(19) United States
(12) Patent Application Publication
(10) Pub. No.: US 2022/0084300 A1
(43) Pub. Date: Mar. 17, 2022

(54) IMAGE PROCESSING APPARATUS AND IMAGE PROCESSING METHOD

(71) Applicant: SONY GROUP CORPORATION, TOKYO (JP)

(72) Inventor: NOBUAKI IZUMI, TOKYO (JP)

(21) Appl. No.: 17/310,850

(22) PCT Filed: Feb. 26, 2020
(86) PCT No.: PCT/JP2020/007592

§ 371 Date: Aug. 26, 2021

(30) Foreign Application Priority Data
Mar. 11, 2019 (JP) 2019-043753

(51) Int. Cl. G06T 19/20; G06T 17/20; G06T 7/00; G06T 7/55

(52) U.S. Cl. CPC G06T 19/20; G06T 17/20; G06T 2219/2012; G06T 7/55; G06T 2219/2004; G06T 7/97

(57) ABSTRACT

The present technology relates to an image processing apparatus and an image processing method that allow for a reduction in processing load of drawing processing. The image processing apparatus includes a determination unit that determines whether or not a subject is captured in texture images corresponding to captured images captured one by each one of a plurality of imaging devices, and an output unit that adds a result of the determination by the determination unit to 3D shape data of a 3D model of the subject and then outputs the result of the determination. The present technology can be applied to, for example, an image processing apparatus that generates data of a 3D model of an object.

### TECHNICAL FIELD

The present technology relates to an image processing apparatus and an image processing method, and more particularly to an image processing apparatus and an image processing method that allow for a reduction in processing load of drawing processing.

### BACKGROUND ART

Various technologies have been proposed for generation and transmission of 3D models. For example, a method has been proposed in which three-dimensional data of a 3D model of a subject is converted into a plurality of texture images and depth images captured from a plurality of viewpoints, transmitted to a reproduction device, and displayed on a reproduction side (for example, see Patent Document 1).

### CITATION LIST

### Patent Document

Patent Document 1: WO 2017/082076 A

### SUMMARY OF THE INVENTION

### Problems to be Solved by the Invention

It is necessary that the reproduction device determine which of the plurality of texture images corresponding to the plurality of viewpoints can be used for pasting of colors of an object to be drawn, and this determination has required a heavy processing load.

The present technology has been made in view of such a situation, and makes it possible to reduce a processing load of drawing processing on a reproduction side.

### Solutions to Problems

A first aspect of the present technology provides an image processing apparatus including: a determination unit that determines whether or not a subject is captured in texture images corresponding to captured images captured one by each one of a plurality of imaging devices; and an output unit that adds a result of the determination by the determination unit to 3D shape data of a 3D model of the subject and then outputs the result of the determination.

The first aspect of the present technology provides an image processing method including: determining, by an image processing apparatus, whether or not a subject is captured in texture images corresponding to captured images captured one by each one of a plurality of imaging devices, and adding a result of the determination to 3D shape data of a 3D model of the subject and then outputting the result of the determination.

In the first aspect of the present technology, whether or not a subject is captured in texture images corresponding to captured images captured one by each one of a plurality of imaging devices is determined, and a result of the determination is added to 3D shape data of a 3D model of the subject and then output.

A second aspect of the present technology provides an image processing apparatus including a drawing processing unit that generates an image of a 3D model of a subject on the basis of 3D shape data containing a determination result that is the 3D shape data of the 3D model to which the determination result indicating whether the subject is captured in a texture image is added.

The second aspect of the present technology provides an image processing method including generating, by an image processing apparatus, an image of a 3D model of a subject on the basis of 3D shape data containing a determination result that is the 3D shape data of the 3D model to which the determination result indicating whether the subject is captured in a texture image is added.

In the second aspect of the present technology, an image of a 3D model of a subject is generated on the basis of 3D shape data containing a determination result that is the 3D shape data of the 3D model to which the determination result indicating whether the subject is captured in a texture image is added.

Note that the image processing apparatuses according to the first and second aspects of the present technology can be achieved by causing a computer to execute a program. The program to be executed by the computer can be provided by being transmitted via a transmission medium or being recorded on a recording medium.

The image processing apparatus may be an independent apparatus, or may be an internal block constituting one apparatus.

### BRIEF DESCRIPTION OF DRAWINGS

FIG. 1 is a diagram illustrating an overview of an image processing system to which the present technology is applied.

FIG. 2 is a block diagram illustrating a configuration example of the image processing system to which the present technology is applied.

FIG. 3 is a diagram illustrating an example of arranging a plurality of imaging devices.

FIG. 4 is a diagram illustrating an example of 3D model data.

FIG. 5 is a diagram illustrating selection of a texture image for pasting color information on a 3D shape of an object.

FIG. 6 is a diagram illustrating pasting of a texture image in a case where there is occlusion.

FIG. 7 is a diagram illustrating an example of a visibility flag.

FIG. 8 is a block diagram illustrating a detailed configuration example of a generation device.

FIG. 9 is a diagram illustrating processing by a visibility determination unit.

FIG. 10 is a diagram illustrating the processing by the visibility determination unit.

FIG. 11 is a diagram illustrating an example of processing of packing mesh data and visibility information.

FIG. 12 is a block diagram illustrating a detailed configuration example of a reproduction device.

FIG. 13 is a flowchart illustrating 3D model data generation processing by the generation device.

FIG. 14 is a flowchart illustrating details of visibility determination processing of step S7 in FIG. 13.

FIG. 15 is a flowchart illustrating camera selection processing by the reproduction device.

FIG. 16 is a flowchart illustrating drawing processing by a drawing processing unit.

FIG. 17 is a block diagram illustrating a modified example of the generation device.

FIG. 18 is a diagram illustrating triangular patch subdivision processing.

FIG. 19 is a diagram illustrating the triangular patch subdivision processing.

FIG. 20 is a diagram illustrating the triangular patch subdivision processing.

FIG. 21 is a block diagram illustrating a configuration example of one embodiment of a computer to which the present technology is applied.

### MODE FOR CARRYING OUT THE INVENTION

A mode for carrying out the present technology (hereinafter referred to as an “embodiment”) will be described below. Note that the description will be made in the order below.

1. Overview of image processing system

2. Configuration example of image processing system

3. Features of image processing system

4. Configuration example of generation device 22

5. Configuration example of reproduction device 25

6. 3D model data generation processing

7. Visibility determination processing

8. Camera selection processing

9. Drawing processing

10. Modified example

11. Configuration example of computer

### 1. Overview of Image Processing System

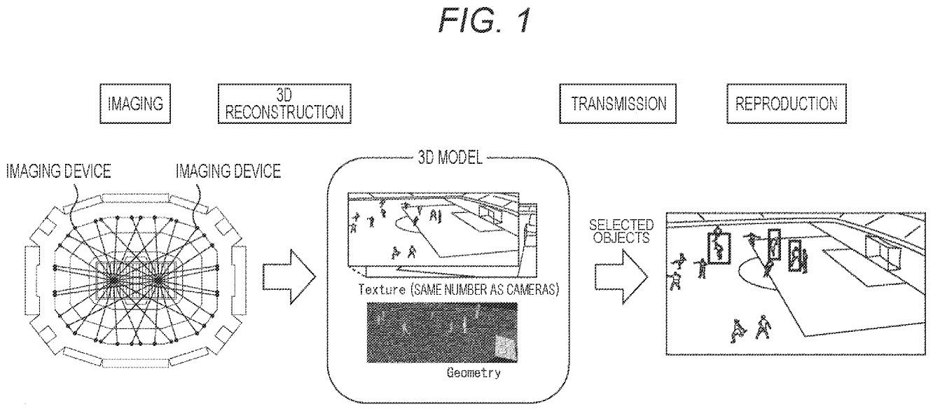

First, with reference to FIG. 1, an overview of an image processing system to which the present technology is applied will be described.

The image processing system to which the present technology is applied is constituted by a distribution side that generates and distributes a 3D model of an object from captured images obtained by imaging with a plurality of imaging devices, and a reproduction side that receives the 3D model transmitted from the distribution side, and then reproduces and displays the 3D model.

On the distribution side, a predetermined imaging space is imaged from the outer periphery thereof with a plurality of imaging devices, and thus a plurality of captured images is obtained. The captured images are constituted by, for example, a moving image. Then, with the use of the captured images obtained from the plurality of imaging devices in different directions, 3D models of a plurality of objects to be displayed in the imaging space are generated. Generation of 3D models of objects is also called reconstruction of 3D models.

FIG. 1 illustrates an example in which the imaging space is set to a field of a soccer stadium, and players and the like on the field are imaged by the plurality of imaging devices arranged on a stand side constituting the outer periphery of the field. When reconstruction of 3D models is performed, for example, a player, a referee, a soccer ball, and a soccer goal on the field are extracted as objects, and a 3D model is generated (reconstructed) for each object. Data of the generated 3D models (hereinafter, also referred to as 3D model data) of a large number of objects is stored in a predetermined storage device.

Then, the 3D model of a predetermined object among the large number of objects existing in the imaging space stored in the predetermined storage device is transmitted in response to a request from the reproduction side, and is reproduced and displayed on the reproduction side.

The reproduction side can make a request for only an object to be viewed among a large number of objects existing in an imaging space, and cause a display device to display the object. For example, the reproduction side assumes a virtual camera having an imaging range that coincides with a viewing range of a viewer, makes a request for, among a large number of objects existing in the imaging space, only objects that can be captured by the virtual camera, and causes the display device to display the objects. The viewpoint of the virtual camera can be set to any position so that the viewer can see the field from any viewpoint in the real world.

In the example of FIG. 1, of the large number of players as generated objects, only three players enclosed by squares are displayed on the display device.

### 2. Configuration Example of Image Processing System

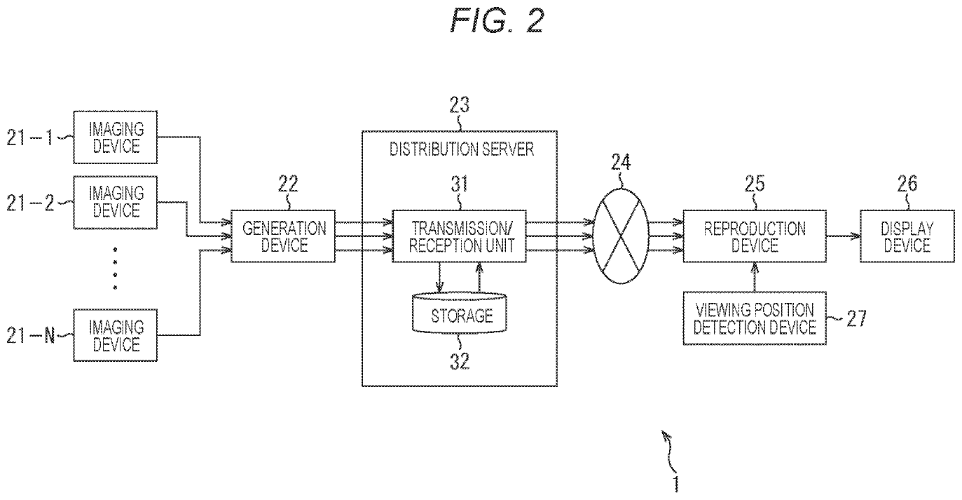

FIG. 2 is a block diagram illustrating a configuration example of an image processing system that enables the image processing described in FIG. 1.

An image processing system 1 is constituted by a distribution side that generates and distributes data of a 3D model from a plurality of captured images obtained from a plurality of imaging devices 21, and a reproduction side that receives the data of the 3D model transmitted from the distribution side and then reproduces and displays the 3D model.

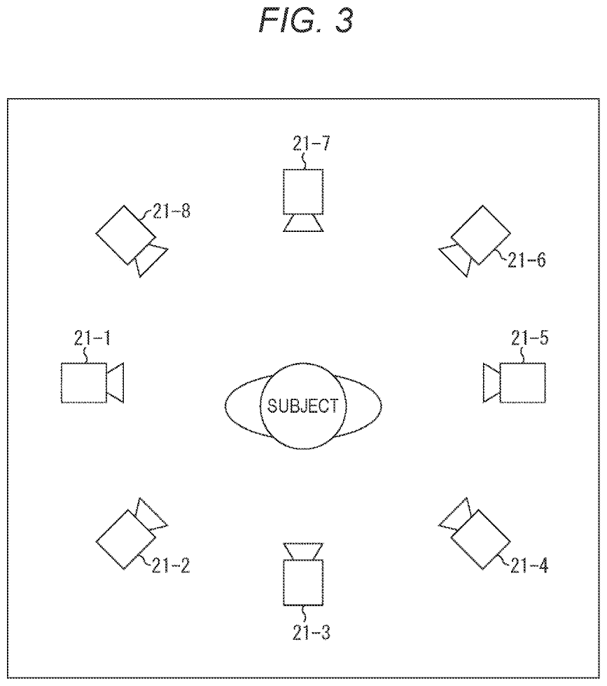

Imaging devices 21-1 to 21-N (N>1) are arranged at different positions in the outer periphery of a subject as illustrated in FIG. 3, for example, to image the subject and supply a generation device 22 with image data of a moving image obtained as a result of the imaging. FIG. 3 illustrates an example in which eight imaging devices 21-1 to 21-8 are arranged. Each of the imaging devices 21-1 to 21-8 images a subject from a direction different from those of other imaging devices 21. The position of each imaging device 21 in a world coordinate system is known.

In the present embodiment, a moving image generated by each imaging device 21 is constituted by a captured image (RGB image) including an R, G, and B wavelengths. Each imaging device 21 supplies the generation device 22 with image data of a moving image (RGB image) obtained by imaging the subject and camera parameters. The camera parameters include at least an external parameter and an internal parameter.

From a plurality of captured images supplied from each of the imaging devices 21-1 to 21-N, the generation device 22 generates image data of texture images of the subject and 3D shape data indicating a 3D shape of the subject, and supplies a distribution server 23 with the image data and the 3D shape data together with the camera parameters of the plurality of imaging devices 21. Hereinafter, image data and 3D shape data of each object are also collectively referred to as 3D model data.

Note that, instead of directly acquiring captured images from the imaging devices 21-1 to 21-N, the generation device 22 may acquire captured images once stored in a predetermined storage unit such as a data server and generate 3D model data.

The distribution server 23 stores 3D model data supplied from the generation device 22, and transmits the 3D model data to a reproduction device 25 via a network 24 in response to a request from the reproduction device 25.

The distribution server 23 includes a transmission/reception unit 31 and a storage 32.

The transmission/reception unit 31 acquires the 3D model data and the camera parameters supplied from the generation device 22, and stores the 3D model data and the camera parameters in the storage 32. Furthermore, the transmission/reception unit 31 transmits the 3D model data and the camera parameters to the reproduction device 25 via the network 24 in response to a request from the reproduction device 25.

Note that the transmission/reception unit 31 can acquire the 3D model data and the camera parameters from the storage 32 and transmit the 3D model data and the camera parameters to the reproduction device 25, or can directly transmit (real-time distribution), to the reproduction device 25, the 3D model data and the camera parameters supplied from the generation device 22 without storing the 3D model data and the camera parameters in the storage 32.

The network 24 is constituted by, for example, the Internet, a telephone network, a satellite communication network, various local area networks (LANs) including Ethernet (registered trademark), or a leased line network such as a wide area network (WAN) or an Internet protocol-virtual private network (IP-VPN).

The reproduction device 25 uses the 3D model data and the camera parameters transmitted from the distribution server 23 via the network 24 to generate (reproduce) an image of an object (object image) viewed from a viewing position of a viewer supplied from a viewing position detection device 27, and supplies the image to a display device 26. More specifically, the reproduction device 25 assumes a virtual camera having an imaging range that coincides with a viewing range of the viewer, generates an image of the object captured by the virtual camera, and causes the display device 26 to display the image. The viewpoint (virtual viewpoint) of the virtual camera is specified by virtual viewpoint information supplied from the viewing position detection device 27. The virtual viewpoint information is constituted by, for example, camera parameters (external parameter and internal parameter) of the virtual camera.

The display device 26 displays an object image supplied from the reproduction device 25. A viewer views the object image displayed on the display device 26. The viewing position detection device 27 detects the viewing position of the viewer, and supplies virtual viewpoint information indicating the viewing position to the reproduction device 25.

The display device 26 and the viewing position detection device 27 may be configured as an integrated device. For example, the display device 26 and the viewing position detection device 27 are constituted by a head-mounted display, detect the position where the viewer has moved, the movement of the head, and the like, and detect the viewing position of the viewer. The viewing position also includes the viewer's line-of-sight direction with respect to the object generated by the reproduction device 25.

As an example in which the display device 26 and the viewing position detection device 27 are configured as separate devices, for example, the viewing position detection device 27 is constituted by, for example, a controller that operates the viewing position. In this case, the viewing position corresponding to an operation on the controller by the viewer is supplied from the viewing position detection device 27 to the reproduction device 25. The reproduction device 25 causes the display device 26 to display an object image corresponding to the designated viewing position.

The display device 26 or the viewing position detection device 27 can also supply, to the reproduction device 25 as necessary, information regarding a display function of the display device 26, such as an image size and an angle of view of an image displayed by the display device 26.

In the image processing system 1 configured as described above, 3D model data of objects, among a large number of objects existing in an imaging space, corresponding to a viewer's viewpoint (virtual viewpoint) is generated by the generation device 22 and transmitted to the reproduction device 25 via the distribution server 23. Then, the reproduction device 25 causes the object image based on the 3D model data to be reproduced and displayed on the display device 26. The generation device 22 is an image processing apparatus that generates 3D model data of an object in accordance with a viewpoint (virtual viewpoint) of a viewer, and the reproduction device 25 is an image processing apparatus that produces an object image based on the 3D model data generated by the generation device 22 and causes the display device 26 to display the object image.

### 3. Features of Image Processing System

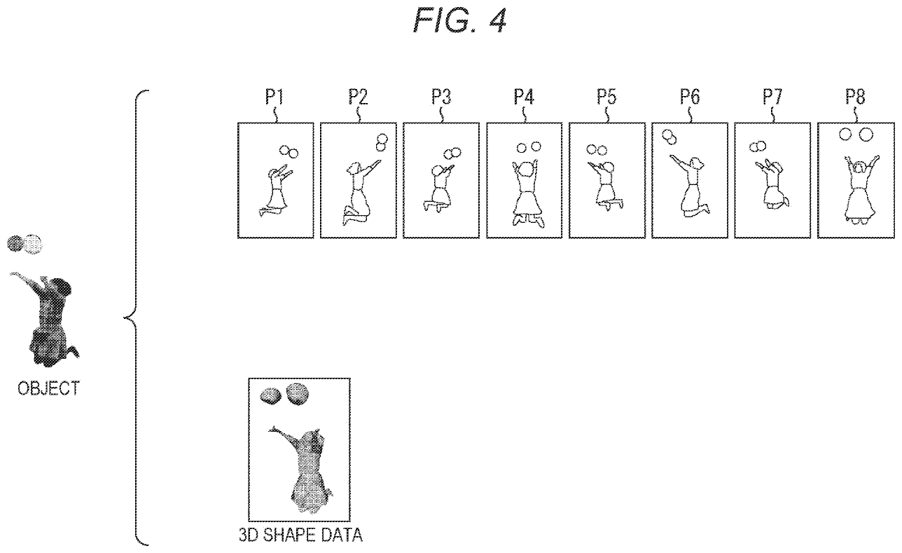

Next, features of the image processing system 1 will be described with reference to FIGS. 4 to 7.

FIG. 4 illustrates an example of 3D model data transmitted from the distribution server 23 to the reproduction device 25.

As 3D model data, image data of texture images of an object (subject) and 3D shape data indicating the 3D shape of the object are transmitted to the reproduction device 25.

The transmitted texture images of the object are, for example, captured images P1 to P8 of the subject captured by the imaging devices 21-1 to 21-8, respectively, as illustrated in FIG. 4.

The 3D shape data of the object is, for example, mesh data in which the 3D shape of the subject is represented by a polygon mesh represented by connections between vertices of triangles (triangular patches) as illustrated in FIG. 4.

In order to generate an object image to be displayed on the display device 26 in accordance with a viewpoint (virtual viewpoint) of a viewer, the reproduction device 25 pastes, in the 3D shape of the object represented by the polygon mesh, color information (RBG value) based on a plurality of texture images captured by a plurality of imaging devices 21.

Here, the reproduction device 25 selects, from among N texture images captured by N imaging devices 21 that are supplied from the distribution server 23, texture images of a plurality of imaging devices 21 that are closer to the virtual viewpoint, and pastes the color information in the 3D shape of the object.

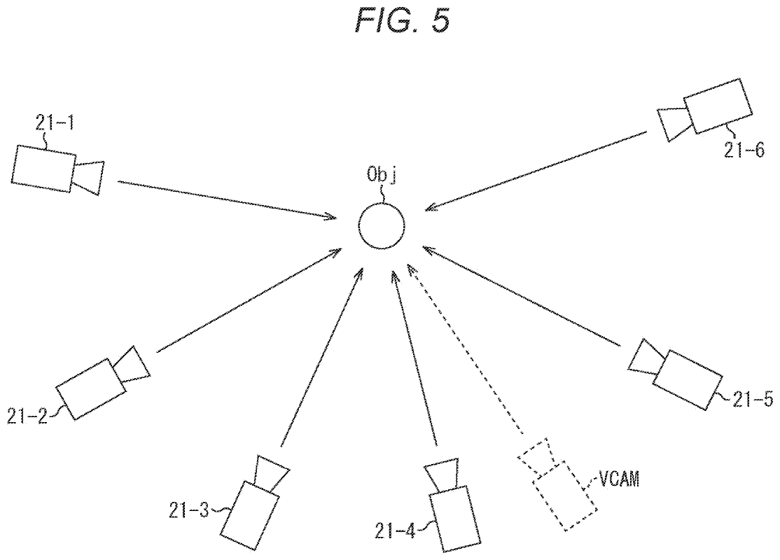

For example, in a case where the reproduction device 25 generates an object image in which an object Obj is viewed from a viewpoint (virtual viewpoint) of a virtual camera VCAM as illustrated in FIG. 5, the reproduction device 25 pastes the color information by using texture images of the three imaging devices 21-3 to 21-5 located closer to the virtual camera VCAM. A method of performing texture mapping using texture images obtained by a plurality of imaging devices 21 located close to the virtual camera VCAM in this way is called view-dependent rendering. Note that color information of a drawing pixel is obtained by blending pieces of color information of three texture images by a predetermined method.

A value of 3D shape data of an object may not always be accurate due to an error or lack of accuracy. In a case where the three-dimensional shape of the object is not accurate, using ray information from imaging devices 21 closer to the viewing position has the advantage that a reduction in error and an improvement in image quality can be obtained. Furthermore, view-dependent rendering can reproduce color information that changes depending on a viewing direction, such as reflection of light.

Incidentally, even in a case where an object is within the angle of view of the imaging device 21, the object may overlap with another object.

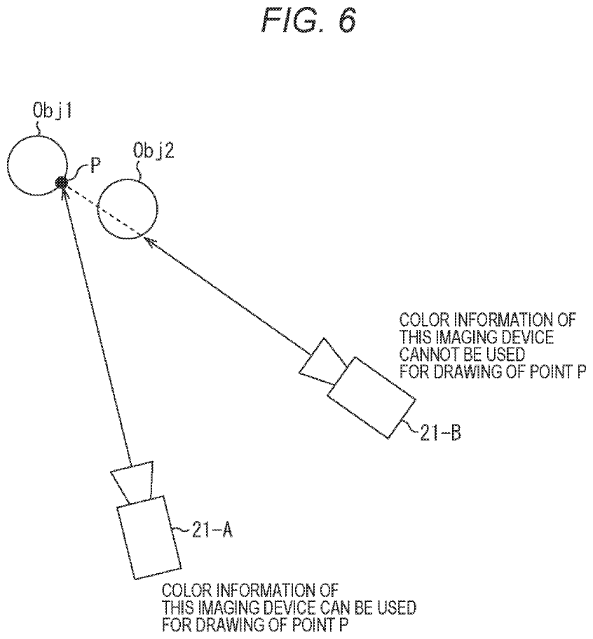

For example, a case is considered in which, as illustrated in FIG. 6, two imaging devices 21-A and 21-B are selected as the imaging devices 21 located close to the virtual camera VCAM, and color information of a point P on an object Obj1 is pasted.

There is an object Obj2 close to the object Obj1. In a texture image of the imaging device 21-B, the point P on the object Obj1 is not captured due to the object Obj2. Thus, of the two imaging devices 21-A and 21-B located close to the virtual camera VCAM, a texture image (color information) of the imaging device 21-A can be used, but a texture image of the imaging device 21-B (color information) cannot be used.

In this way, in a case where there is overlap (occlusion) between objects, even a texture image (color information) of an imaging device 21 located close to the virtual camera VCAM may not be able to be used.

Thus, it has normally been necessary for the reproduction device 25, which generates an image to be reproduced and displayed, to generate a depth map in which information regarding the distance from an imaging device 21 to the object (depth information) has been calculated, and determine whether or not a drawing point P is captured in the texture image of the imaging device 21, and there has been a problem in that this processing is heavy.

Thus, in the image processing system 1, the generation device 22 determines in advance, for each point P constituting a drawing surface of an object, whether or not the point P is captured in a texture image of the imaging device 21 to be transmitted, and then transmits a result of the determination as a flag to the reproduction device 25. This flag indicates information regarding visibility in the texture image of the imaging device 21, and is called a visibility flag.

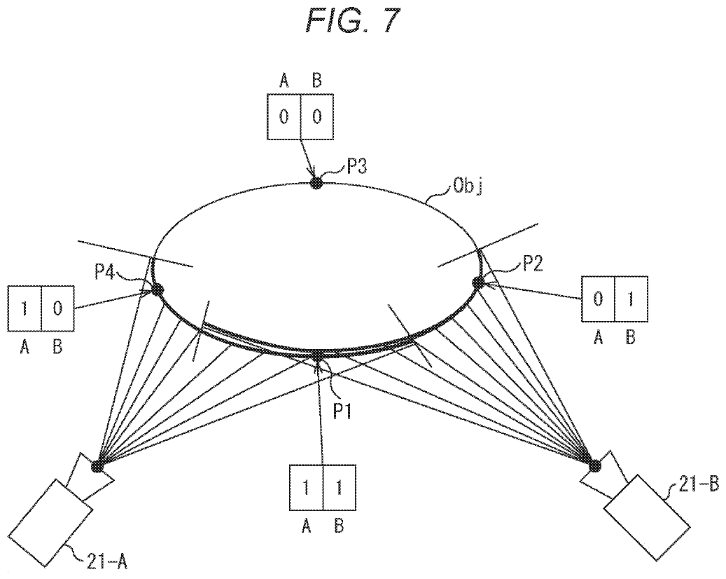

FIG. 7 illustrates an example of visibility flags of the two imaging devices 21-A and 21-B that have imaged the object Obj.

When points P on the surface of the object Obj are determined, visibility flags are also determined. For each point P on the surface of the object Obj, whether the point P is captured or not is determined for each imaging device 21.

In the example of FIG. 7, a point P1 on the surface of the object Obj is captured by both the imaging devices 21-A and 21-B, and this is expressed as visibility flag_P1 (A, B)=(1, 1). A point P2 on the surface of the object Obj is not captured by the imaging device 21-A, but is captured by the imaging device 21-B, and this is expressed as visibility flag_P2 (A, B)=(0, 1).

A point P3 on the surface of the object Obj is not captured by either of the imaging devices 21-A and 21-B, and this is expressed as visibility flag_P3 (A, B)=(0, 0). A point P4 on the surface of the object Obj is captured by the imaging device 21-A, but is not captured by the imaging device 21-B, and this is expressed as visibility flag_P2 (A, B)=(1, 0).

In this way, a visibility flag is determined for each imaging device 21 for each point on the surface of the object Obj, and visibility information of the N imaging devices 21 is total of N bits of information.

In the image processing system 1, the generation device 22 generates a visibility flag and supplies it to the reproduction device 25 together with 3D model data and a camera parameter, and this makes it unnecessary for the reproduction device 25 to determine whether or not a drawing point P is captured in a texture image of the imaging device 21. As a result, a drawing load of the reproduction device 25 can be mitigated.

The generation device 22 generates and provides data represented by a polygon mesh as 3D shape data indicating the 3D shape of an object, and the generation device 22 generates and adds a visibility flag for each triangular patch of the polygon mesh.

Hereinafter, detailed configurations of the generation device 22 and the reproduction device 25 will be described.

### 4. Configuration Example of Generation Device 22

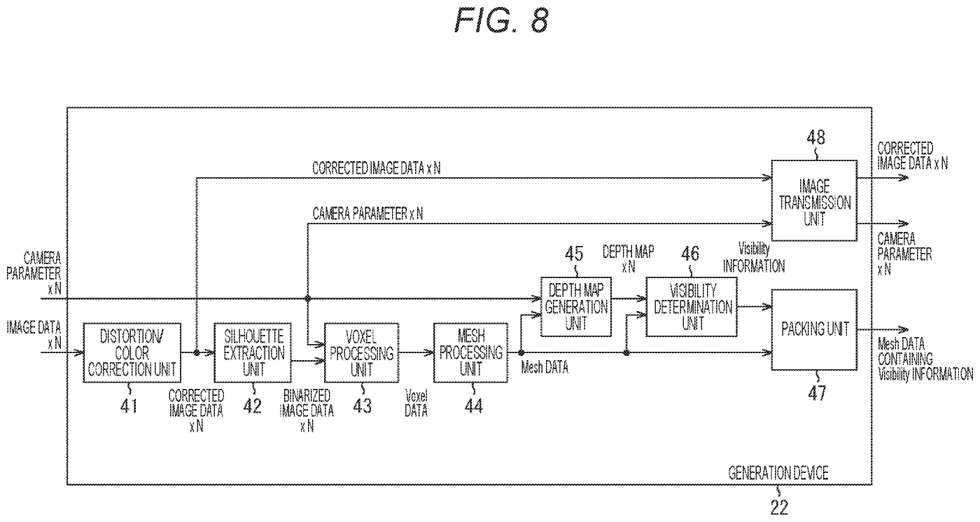

FIG. 8 is a block diagram illustrating a detailed configuration example of the generation device 22.

The generation device 22 includes a distortion/color correction unit 41, a silhouette extraction unit 42, a voxel processing unit 43, a mesh processing unit 44, a depth map generation unit 45, a visibility determination unit 46, a packing unit 47, and an image transmission unit 48.

Image data of moving images captured by each of the N imaging devices 21 is supplied to the generation device 22. The moving images are constituted by a plurality of RGB texture images obtained in chronological order. Furthermore, the generation device 22 is also supplied with camera parameters of each of the N imaging devices 21. Note that the camera parameters may be set (input) by a setting unit of the generation device 22 on the basis of a user's operation instead of being supplied from the imaging device 21.

The image data of the moving images from each imaging device 21 is supplied to the distortion/color correction unit 41, and the camera parameters are supplied to the voxel processing unit 43, the depth map generation unit 45, and the image transmission unit 48.

The distortion/color correction unit 41 corrects lens distortion and color of each imaging device 21 for N texture images supplied from the N imaging devices 21. As a result, the distortion and color variation between the N texture images are corrected, so that it is possible to suppress a feeling of strangeness when colors of a plurality of texture images are blended at the time of drawing. The image data of the corrected N texture images is supplied to the silhouette extraction unit 42 and the image transmission unit 48.

The silhouette extraction unit 42 generates a silhouette image in which an area of a subject as an object to be drawn is represented by a silhouette for each of the corrected N texture images supplied from the distortion/color correction unit 41.

The silhouette image is, for example, a binarized image in which a pixel value of each pixel is binarized to “0” or “1”, and the area of the subject is set to a pixel value of “1” and represented in white. Areas other than the subject are set to a pixel value of “0” and are represented in black.

Note that the detection method for detecting the silhouette of the subject in the texture image is not particularly limited, and any method may be adopted. For example, it is possible to adopt a method of detecting the silhouette by regarding two adjacent imaging devices 21 as a stereo camera, calculating the distance to the subject by calculating a parallax from two texture images, and separating a foreground and a background. Furthermore, it is also possible to adopt a method of detecting the silhouette by capturing and saving in advance a background image in which only a background is captured and the subject is not included, and obtaining a difference between a texture image and the background image by using a background subtraction method. Alternatively, it is possible to more accurately detect a silhouette of a person in a captured image by using a method in which graph cut and stereo vision are used (“Bi-Layer segmentation of binocular stereo video” V. Kolmogorov, A. Blake et al. Microsoft Research Ltd., Cambridge, UK). Data of N silhouette images generated from the N texture images is supplied to the voxel processing unit 43.

The voxel processing unit 43 projects, in accordance with the camera parameters, the N silhouette images supplied from the silhouette extraction unit 42, and uses a Visual Hull method for carving out a three-dimensional shape to generate (restore) the three-dimensional shape of the object. The three-dimensional shape of the object is represented by voxel data indicating, for example, for each three-dimensional grid (voxel), whether the grid belongs to the object or not. The voxel data representing the three-dimensional shape of the object is supplied to the mesh processing unit 44.

The mesh processing unit 44 converts the voxel data representing the three-dimensional shape of the object supplied from the voxel processing unit 43 into a polygon mesh data format that can be easily rendered by a display device. An algorithm such as marching cubes can be used for the conversion of the data format. The mesh processing unit 44 supplies the mesh data after the format conversion represented by triangular patches to the depth map generation unit 45, the visibility determination unit 46, and the packing unit 47.

The depth map generation unit 45 generates N depth images (depth maps) corresponding to the N texture images by using the camera parameters of the N imaging devices 21 and the mesh data representing the three-dimensional shape of the object.

Two-dimensional coordinates (u, v) in an image captured by one imaging device 21 and three-dimensional coordinates (X, Y, Z) in a world coordinate system of the object captured in the image are represented by the following Equation (1) in which an internal parameter A and an external parameter R t of the camera are used.

[Math. 1]

sm′=A[R|t]M (1)

In Equation (1), m′ is a matrix corresponding to the two-dimensional position of the image, and M is a matrix corresponding to the three-dimensional coordinates in the world coordinate system. Equation (1) is represented in more detail by Equation (2).

$$\begin{matrix}[ Math . 2 ] & \\ S [ \begin{matrix}u \\ v \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}X \\ Y \\ Z \\ 1\end{matrix} ] & ( 2 )\end{matrix}$$

In Equation (2), (u, v) is two-dimensional coordinates in the image, and fₓ and f_{y} are focal lengths. Furthermore, Cₓ and C_{y} are principal points, r₁₁ to r₁₃, r₂₁ to r₂₃, r₃₁ to r₃₃, and t₁ to t₃ are parameters, and (X, Y, Z) are three-dimensional coordinates in the world coordinate system.

It is therefore possible to obtain the three-dimensional coordinates corresponding to the two-dimensional coordinates of each pixel in a texture image by using the camera parameters according to the Equation (1) or (2), and a depth image corresponding to the texture image can be generated. The generated N depth images are supplied to the visibility determination unit 46.

The visibility determination unit 46 uses the N depth images to determine whether or not each point on the object is captured in the texture image captured by the imaging device 21 for each of the N texture images.

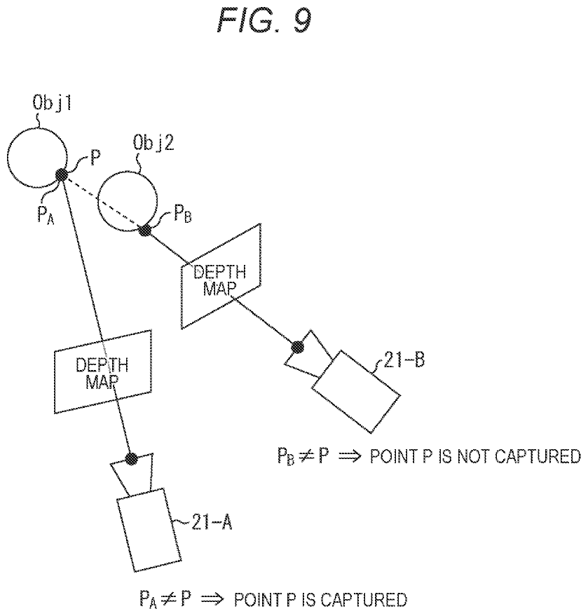

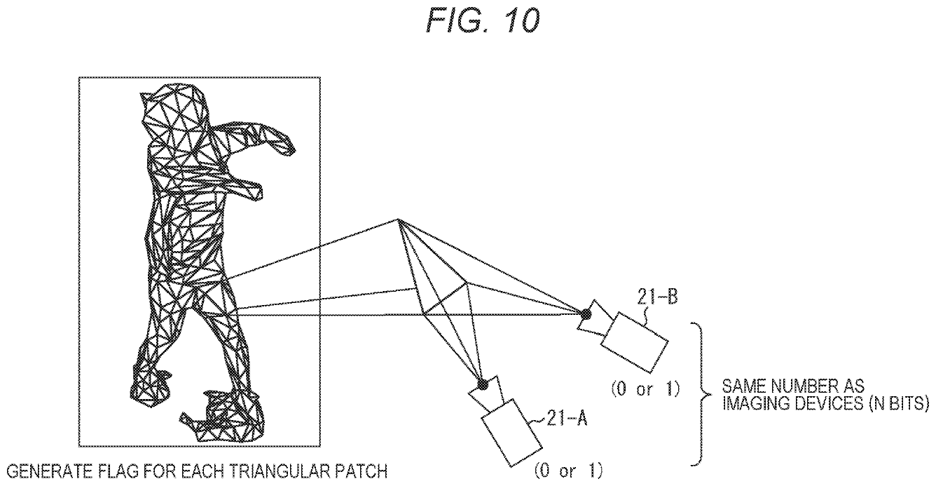

Processing by the visibility determination unit 46 will be described with reference to FIGS. 9 and 10.

For example, a case where the visibility determination unit 46 determines whether a point P on an object Obj1 illustrated in FIG. 9 is captured in the texture image of each of the imaging devices 21-A and 21-B will be described. Here, the coordinates of the point P on the object Obj1 are known from mesh data representing the three-dimensional shape of the object supplied from the mesh processing unit 44.

The visibility determination unit 46 calculates coordinates (i_{A}, j_{A}) in a projection screen in which the position of the point P on the object Obj1 is projected onto an imaging range of the imaging device 21-A, and a depth value d_{A} of the coordinates (i_{A}, j_{A}) is acquired from a depth image of the imaging device 21-A supplied from the depth map generation unit 45. The depth value d_{A} is a depth value stored in the coordinates (i_{A}, j_{A}) of the depth image of the imaging device 21-A supplied from the depth map generation unit 45.

Next, from the coordinates (i_{A}, j_{A}), the depth value d_{A}, and a camera parameter of the imaging device 21-A, the visibility determination unit 46 calculates three-dimensional coordinates (x_{A}, y_{A}, z_{A}) in a world coordinate system of the coordinates (i_{A}, j_{A}) in the projection screen of the imaging device 21-A.

In a similar manner, for the imaging device 21-B, from coordinates (i_{B}, j_{B}) in a projection screen of the imaging device 21-B, a depth value dB, and a camera parameter of the imaging device 21-B, three-dimensional coordinates (x_{B}, y_{B}, z_{B}) in a world coordinate system of the coordinates (i_{B}, j_{B}) in the projection screen of the imaging device 21-B are calculated.

Next, the visibility determination unit 46 determines whether the point P is captured in the texture image of the imaging device 21 by determining whether or not the calculated three-dimensional coordinates (x, y, z) coincide with the known coordinates of the point P on the object Obj1.

In the example illustrated in FIG. 9, the three-dimensional coordinates (x_{A}, y_{A}, z_{A}) calculated for the imaging device 21-A correspond to a point P_{A}, which means that the point P is the point P_{A}, and it is determined that the point P on the object Obj1 is captured in the texture image of device 21-A.

On the other hand, the three-dimensional coordinates (x_{B}, y_{B}, z_{B}) calculated for the imaging device 21-B are the coordinates of a point PB on the object Obj2, not the coordinates of the point P_{A}. Thus, the point P is not the point PB, and it is determined that the point P on the object Obj1 is not captured in the texture image of the imaging device 21-B.

As illustrated in FIG. 10, the visibility determination unit 46 generates a visibility flag indicating a result of determination on visibility in the texture image of each imaging device 21 for each triangular patch of mesh data, which is a three-dimensional shape of the object.

In a case where the entire area of the triangular patch is captured in the texture image of the imaging device 21, a visibility flag of “1” is set. In a case where even a part of the area of the triangular patch is not captured in the texture image of the imaging device 21, a visibility flag of “0” is set.

Visibility flags are generated one for each of the N imaging devices 21 for one triangular patch, and the visibility flags include N bits of information for one triangular patch.

Returning to FIG. 8, the visibility determination unit 46 generates visibility information represented by N bits of information for each triangular patch of mesh data, and supplies the visibility information to the packing unit 47.

The packing unit 47 packs (combines) polygon mesh data supplied from the mesh processing unit 44 and the visibility information supplied from the visibility determination unit 46, and generates mesh data containing the visibility information.

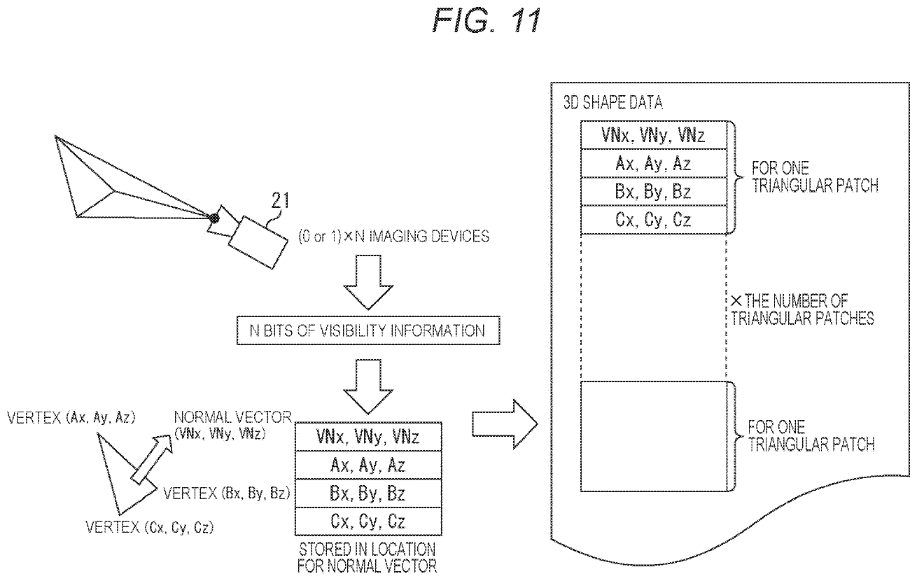

FIG. 11 is a diagram illustrating an example of the processing of packing the mesh data and the visibility information.

As described above, the visibility flags include N bits of information for one triangular patch.

In many of data formats for polygon mesh data, coordinate information of three vertices of a triangle and information of a normal vector of the triangle (normal vector information) are included. In the present embodiment, since normal vector information is not used, N bits of visibility information can be stored in a data storage location for normal vector information. It is assumed that the normal vector information has an area sufficient for storing at least N bits of data.

Alternatively, for example, in a case where each of VNx, VNy, and VNz in a normal vector (VNx, VNy, VNz) has a 32-bit data area, it is possible to use 22 bits for the normal vector and 10 bits for the visibility information.

Note that, in a case where visibility information cannot be stored in the data storage location for normal vector information, a storage location dedicated to visibility information may be added.

As described above, the packing unit 47 adds the visibility information to the polygon mesh data to generate the mesh data containing the visibility information.

Returning to FIG. 8, the packing unit 47 outputs the generated mesh data containing the visibility information to the transmission/reception unit 31 of the distribution server 23. Note that the packing unit 47 also serves as an output unit that outputs the generated mesh data containing the visibility information to another device.

After a captured image (texture image) captured by each of the N imaging devices 21 has been corrected by the distortion/color correction unit 41, the image transmission unit 48 outputs, to the distribution server 23, image data of the N texture images and the camera parameter of each of the N imaging devices 21.

Specifically, the image transmission unit 48 outputs, to the distribution server 23, N video streams, which are streams of moving images corrected by the distortion/color correction unit 41 for each imaging device 21. The image transmission unit 48 may output, to the distribution server 23, coded streams compressed by a predetermined compression coding method. The camera parameters are transmitted separately from the video streams.

### 5. Configuration Example of Reproduction Device 25

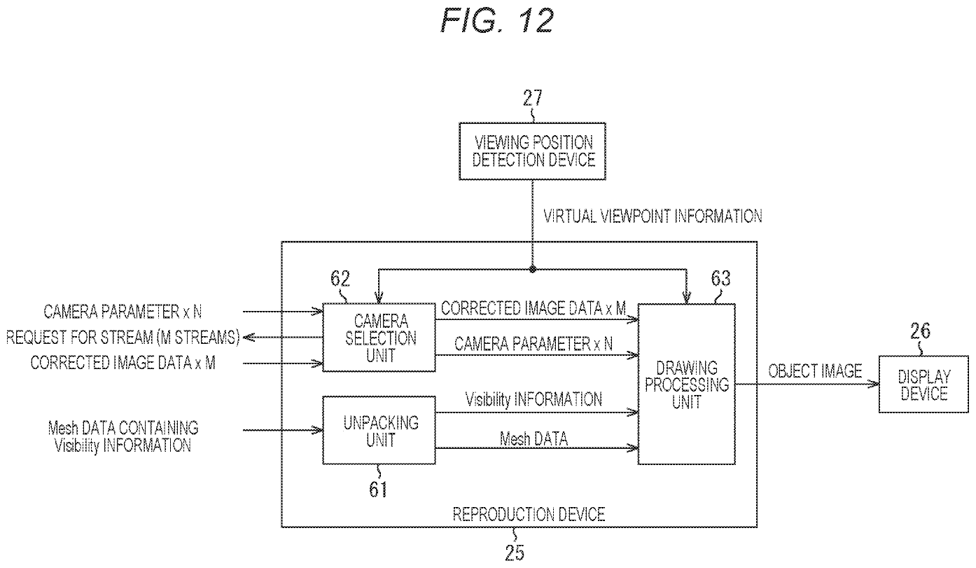

FIG. 12 is a block diagram illustrating a detailed configuration example of the reproduction device 25.

The reproduction device 25 includes an unpacking unit 61, a camera selection unit 62, and a drawing processing unit 63.

The unpacking unit 61 performs processing that is the reverse of the processing by the packing unit 47 of the reproduction device 25. That is, the unpacking unit 61 separates the mesh data containing the visibility information transmitted as 3D shape data of the object from the distribution server 23 into the visibility information and the polygon mesh data, and supplies the visibility information and the polygon mesh data to the drawing processing unit 63. The unpacking unit 61 also serves as a separation unit that separates the mesh data containing the visibility information into the visibility information and the polygon mesh data.

The camera parameter of each of the N imaging devices 21 is supplied to the camera selection unit 62.

On the basis of virtual viewpoint information indicating a viewing position of a viewer supplied from the viewing position detection device 27 (FIG. 2), the camera selection unit 62 selects, from among the N imaging devices 21, M imaging devices 21 that are closer to the viewing position of the viewer. The virtual viewpoint information is constituted by a camera parameter of a virtual camera, and the M imaging devices 21 can be selected by comparison with the camera parameter of each of the N imaging devices 21. In a case where the value M, which is the number of selected imaging devices, is smaller than N, which is the number of the imaging devices 21 (M<N), the processing load can be mitigated. Depending on processing capacity of the reproduction device 25, it is possible that M=N, that is, the total number of the imaging devices 21 may be selected.

The camera selection unit 62 requests and acquires image data of the texture images corresponding to the selected M imaging devices 21 from the distribution server 23. The image data of the texture images is, for example, a video stream for each imaging device 21. This image data of the texture images is data in which distortion and color in the texture images are corrected by the generation device 22.

The camera selection unit 62 supplies the drawing processing unit 63 with the camera parameters and the image data of the texture images corresponding to the selected M imaging devices 21.

The drawing processing unit 63 performs rendering processing of drawing an image of the object on the basis of the viewing position of the viewer. That is, the drawing processing unit 63 generates an image (object image) of the object viewed from the viewing position of the viewer on the basis of the virtual viewpoint information supplied from the viewing position detection device 27, and supplies the image to the display device 26 so that the image is displayed.

The drawing processing unit 63 refers to the visibility information supplied from the unpacking unit 61, and selects, from among the M texture images, K (K≤M) texture images in which a drawing point is captured. Moreover, the drawing processing unit 63 determines, from among the selected K texture images, L (L≤K) texture images to be preferentially used. As the L texture images, with reference to three-dimensional positions (imaging positions) of the imaging devices 21 that have captured the K texture images, texture images in which the angle between the viewing position and the imaging device 21 is smaller are adopted.

The drawing processing unit 63 blends pieces of color information (R, G, and B values) of the determined L texture images, and determines color information of a drawing point P of the object. For example, a blend ratio Blend(i) of an i-th texture image among the L texture images can be calculated by the following Equation (3) and Equation (4).

$$\begin{matrix}[ Math . 3 ] & \\ angBlend ( i ) = max ( 0.1 - \frac{angDiff ( i )}{angMAX} ) & ( 3 ) \\ Blend ( i ) = \frac{angBlend ( i )}{\sum angBlend ( j )} & ( 4 )\end{matrix}$$

In Equation (3), angBlend(i) represents the blend ratio of the i-th texture image before normalization, angDiff(i) represents an angle of the imaging device 21 that has captured the i-th texture image with respect to the viewing position, and angMAX represents a maximum value of angDiff(i) of the L texture images. ΣangBlend(j) in Equation (4) represents the sum of angBlend(j) (j=1 to L) of the L texture images.

The drawing processing unit 63 blends pieces of color information of the L (i=1 to L) texture images with the blend ratio Blend(i), and determines color information of the drawing point P of the object.

Note that the processing of blending the L texture images is not limited to the processing described above, and other methods may be used. The blending calculation formula is only required to satisfy, for example, the following conditions: in a case where the viewing position is the same as the position of an imaging device 21, the color information is close to that of the texture image obtained by that imaging device 21; in a case where the viewing position has changed between imaging devices 21, the blend ratio Blend(i) changes smoothly both temporally and spatially; and the number of textures L to be used is variable.

### 6. 3D Model Data Generation Processing

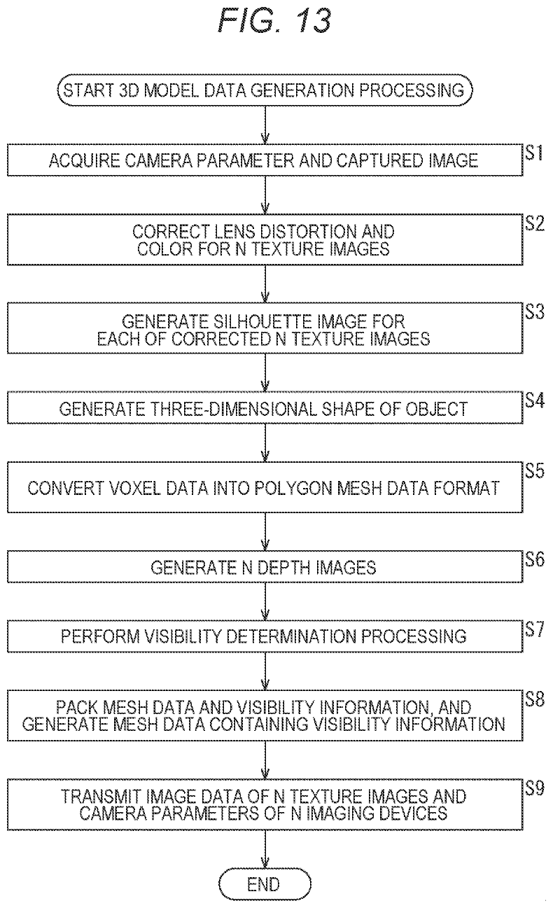

Next, 3D model data generation processing by the generation device 22 will be described with reference to a flowchart in FIG. 13. This processing is started, for example, when captured images of a subject or camera parameters are supplied from the N imaging devices 21.

First, in step S1, the generation device 22 acquires a camera parameter and a captured image supplied from each of the N imaging devices 21. Image data of the captured images is supplied to the distortion/color correction unit 41, and the camera parameters are supplied to the voxel processing unit 43, the depth map generation unit 45, and the image transmission unit 48. The captured images are a part of a moving image that is sequentially supplied, and are texture images that define textures of the subject.

In step S2, the distortion/color correction unit 41 corrects the lens distortion and color of each imaging device 21 for N texture images. The corrected N texture images are supplied to the silhouette extraction unit 42 and the image transmission unit 48.

In step S3, the silhouette extraction unit 42 generates a silhouette image in which the area of the subject as an object is represented by a silhouette for each of the corrected N texture images supplied from the distortion/color correction unit 41, and supplies the silhouette image to the voxel processing unit 43.

In step S4, the voxel processing unit 43 projects, in accordance with the camera parameters, N silhouette images supplied from the silhouette extraction unit 42, and uses the Visual Hull method for carving out a three-dimensional shape to generate (restore) the three-dimensional shape of the object. Voxel data representing the three-dimensional shape of the object is supplied to the mesh processing unit 44.

In step S5, the mesh processing unit 44 converts the voxel data representing the three-dimensional shape of the object supplied from the voxel processing unit 43 into a polygon mesh data format. The mesh data after the format conversion is supplied to the depth map generation unit 45, the visibility determination unit 46, and the packing unit 47.

In step S6, the depth map generation unit 45 generates N depth images corresponding to the N texture images (after correction of color and distortion) by using the camera parameters of the N imaging devices 21 and the mesh data representing the three-dimensional shape of the object. The generated N depth images are supplied to the visibility determination unit 46.

In step S7, the visibility determination unit 46 performs visibility determination processing for determining, for each of the N texture images, whether or not each point on the object is captured in the texture image captured by the imaging device 21. The visibility determination unit 46 supplies, to the packing unit 47, visibility information of the mesh data for each triangular patch, which is a result of the visibility determination processing.

In step S8, the packing unit 47 packs the polygon mesh data supplied from the mesh processing unit 44 and the visibility information supplied from the visibility determination unit 46, and generates mesh data containing the visibility information. Then, the packing unit 47 outputs the generated mesh data containing the visibility information to the distribution server 23.

In step S9, the image transmission unit 48 outputs, to the distribution server 23, the image data of the N texture images corrected by the distortion/color correction unit 41 and the camera parameter of each of the N imaging devices 21.

The processing of step S8 and the processing of step S9 are in no particular order. That is, the processing of step S9 may be executed before the processing of step S8, or the processing of step S8 and the processing of step S9 may be performed at the same time.

The processing of steps S1 to S9 described above is repeatedly executed while captured images are being supplied from the N imaging devices 21.

### 7. Visibility Determination Processing

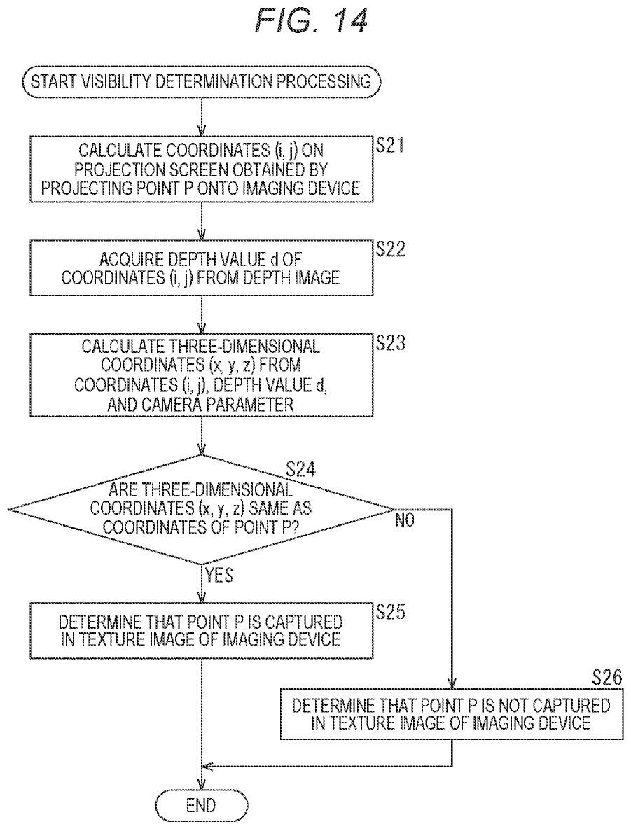

Next, details of the visibility determination processing in step S7 in FIG. 13 will be described with reference to a flowchart in FIG. 14.

First, in step S21, the visibility determination unit 46 calculates coordinates (i, j) in a projection screen obtained by projecting a predetermined point P on the object to be drawn on the reproduction side onto the imaging device 21. The coordinates of the point P are known from the mesh data representing the three-dimensional shape of the object supplied from the mesh processing unit 44.

In step S22, the visibility determination unit 46 acquires a depth value d of the coordinates (i, j) from the depth image of the imaging device 21 supplied from the depth map generation unit 45. A depth value stored in the coordinates (i, j) of a depth image of the imaging device 21 supplied from the depth map generation unit 45 is the depth value d.

In step S23, from the coordinates (i, j), the depth value d, and the camera parameter of the imaging device 21, the visibility determination unit 46 calculates three-dimensional coordinates (x, y, z) in a world coordinate system of the coordinates (i, j) in the projection screen of the imaging device 21.

In step S24, the visibility determination unit 46 determines whether the calculated three-dimensional coordinates (x, y, z) in the world coordinate system are the same as the coordinates of the point P. For example, in a case where the calculated three-dimensional coordinates (x, y, z) in the world coordinate system are within a predetermined error range with respect to the known coordinates of the point P, it is determined that the three-dimensional coordinates (x, y, z) are the same as the coordinates of the point P.

If it is determined in step S24 that the three-dimensional coordinates (x, y, z) calculated from the projection screen projected onto the imaging device 21 are the same as those of the point P, the processing proceeds to step S25. The visibility determination unit 46 determines that the point P is captured in the texture image of the imaging device 21, and the processing ends.

On the other hand, if it is determined in step S24 that the three-dimensional coordinates (x, y, z) calculated from the projection screen projected onto the imaging device 21 are not the same as those of the point P, the processing proceeds to step S26. The visibility determination unit 46 determines that the point P is not captured in the texture image of the imaging device 21, and the processing ends.

The above processing is executed for all the points P on the object and all the imaging devices 21.

### 8. Camera Selection Processing

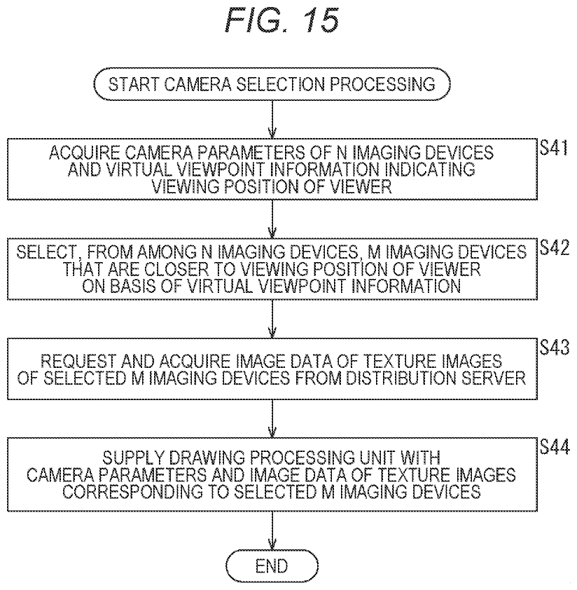

FIG. 15 is a flowchart of camera selection processing by the camera selection unit 62 of the reproduction device 25.

First, in step S41, the camera selection unit 62 acquires camera parameters of N imaging devices 21 and virtual viewpoint information indicating a viewing position of a viewer. The camera parameter of each of the N imaging devices 21 is supplied from the distribution server 23, and the virtual viewpoint information is supplied from the viewing position detection device 27.

In step S42, the camera selection unit 62 selects, from among the N imaging devices 21, M imaging devices 21 that are closer to the viewing position of the viewer on the basis of the virtual viewpoint information.

In step S43, the camera selection unit 62 requests and acquires image data of texture images of the selected M imaging devices 21 from the distribution server 23. The image data of the texture images of the M imaging devices 21 is transmitted from the distribution server 23 as M video streams.

In step S44, the camera selection unit 62 supplies the drawing processing unit 63 with the camera parameters and the image data of the texture images corresponding to the selected M imaging devices 21, and the processing ends.

### 9. Drawing Processing

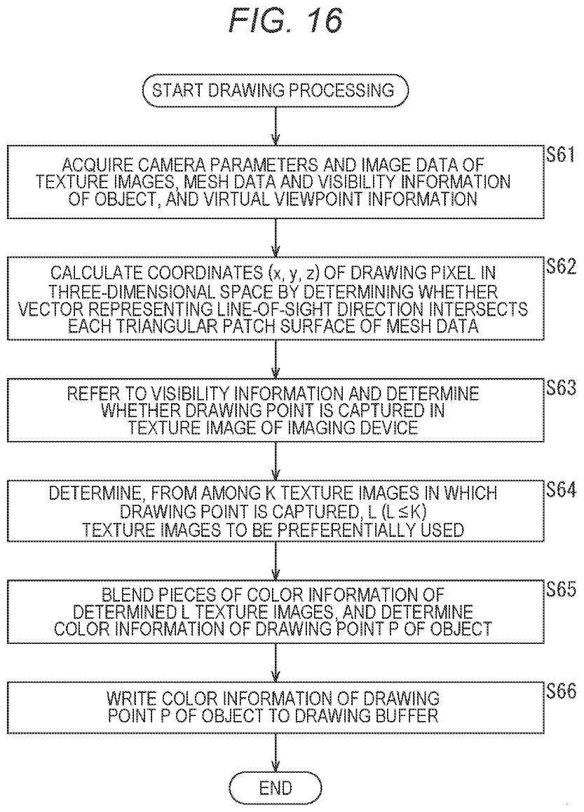

FIG. 16 is a flowchart of drawing processing by the drawing processing unit 63.

First, in step S61, the drawing processing unit 63 acquires camera parameters and image data of texture images corresponding to M imaging devices 21, and mesh data and visibility information of an object. Furthermore, the drawing processing unit 63 also acquires virtual viewpoint information that indicates a viewing position of a viewer and is supplied from the viewing position detection device 27.

In step S62, the drawing processing unit 63 calculates coordinates (x, y, z) of a drawing pixel in a three-dimensional space by determining whether a vector representing a line-of-sight direction of the viewer intersects each triangular patch surface of the mesh data. Hereinafter, for the sake of simplicity, the coordinates (x, y, z) of the drawing pixel in the three-dimensional space are referred to as a drawing point.

In step S63, the drawing processing unit 63 refers to the visibility information and determines, for each of the M imaging devices 21, whether the drawing point is captured in the texture image of the imaging device 21. The number of texture images in which it is determined here that the drawing point is captured is expressed as K (K≤M).

In step S64, the drawing processing unit 63 determines, from among the K texture images in which the drawing point is captured, L (L≤K) texture images to be preferentially used. As the L texture images, texture images of the imaging devices 21 having a smaller angle with respect to the viewing position are adopted.

In step S65, the drawing processing unit 63 blends pieces of color information (R, G, and B values) of the determined L texture images, and determines color information of a drawing point P of the object.

In step S66, the drawing processing unit 63 writes the color information of the drawing point P of the object to a drawing buffer.

When the processing of steps S62 to S66 has been executed for all points in a viewing range of the viewer, an object image corresponding to the viewing position is generated in the drawing buffer of the drawing processing unit 63 and displayed on the display device 26.

### 10. Modified Example

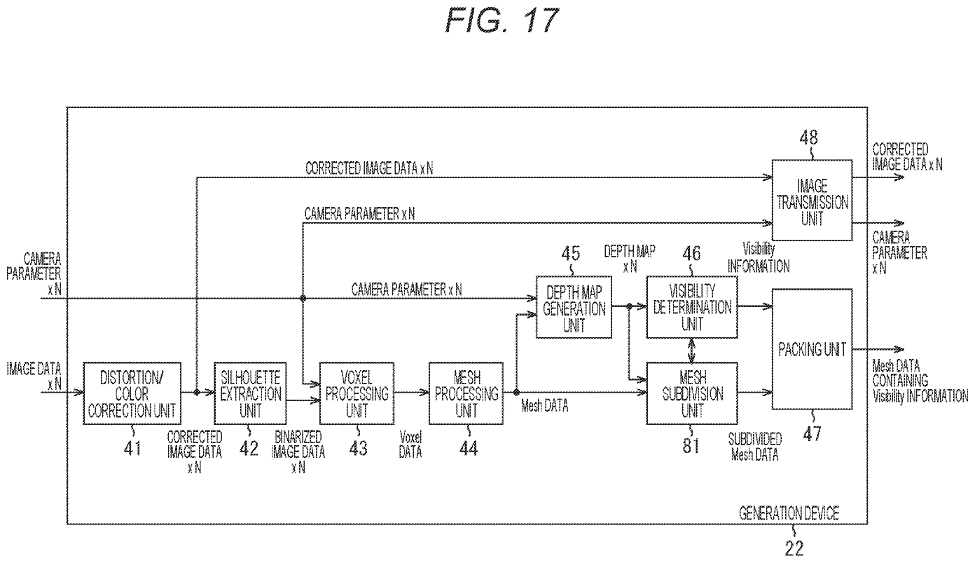

FIG. 17 is a block diagram illustrating a modified example of the generation device 22.

The generation device 22 according to a modified example in FIG. 17 differs from the configuration of the generation device 22 illustrated in FIG. 8 in that a mesh subdivision unit 81 is newly added between the mesh processing unit 44 and the packing unit 47.

The mesh subdivision unit 81 is supplied with mesh data representing a three-dimensional shape of an object from the mesh processing unit 44, and is supplied with N depth images (depth maps) from the depth map generation unit 45.

The mesh subdivision unit 81 subdivides triangular patches on the basis of the mesh data supplied from the mesh processing unit 44 so that boundaries between visibility flags “0” and “1” coincide with boundaries between triangular patches. The mesh subdivision unit 81 supplies the mesh data after the subdivision processing to the packing unit 47.

In the triangular patch subdivision processing, the mesh subdivision unit 81 and the visibility determination unit 46 pass visibility information and the mesh data after the subdivision processing to each other as necessary.

Except that the mesh subdivision unit 81 performs the triangular patch subdivision processing, other parts of the configuration of the generation device 22 in FIG. 17 are similar to the configuration of the generation device 22 illustrated in FIG. 8.

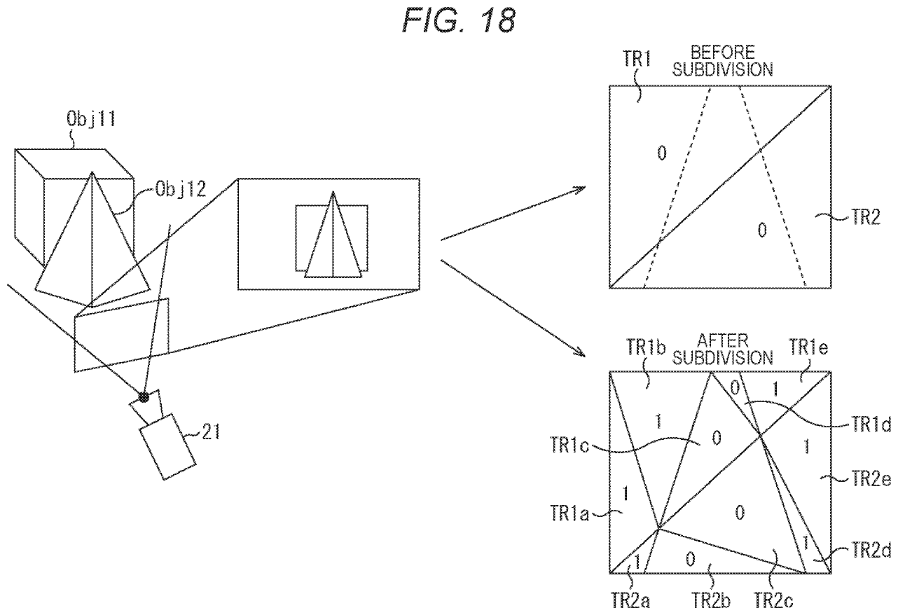

The triangular patch subdivision processing will be described with reference to FIGS. 18 to 20.

For example, a situation is assumed in which an object Obj11 and an object Obj12 are captured by a predetermined imaging device 21, and a part of the object Obj11 is hidden by the object Obj12 as illustrated in FIG. 18.

Mesh data before subdivision of the object Obj11 captured by the imaging device 21, in other words, mesh data supplied from the mesh processing unit 44 to the mesh subdivision unit 81, is constituted by two triangular patches TR1 and TR2, as illustrated in the upper right of FIG. 18.

The object Obj12 is inside an area defined by two broken lines of the two triangular patches TR1 and TR2. In a case where even a part of a triangular patch is hidden, the visibility flag is set to “0”, so the visibility flags of the two triangular patches TR1 and TR2 are both set to “0”. The “0”s in the triangular patches TR1 and TR2 represent the visibility flags.

On the other hand, a state of the two triangular patches TR1 and TR2 after the mesh subdivision unit 81 has performed the triangular patch subdivision processing is illustrated in the lower right of FIG. 18.

After the triangular patch subdivision processing, the triangular patch TR1 is divided into triangular patches TR1a to TR1e, and the triangular patch TR2 is divided into triangular patches TR2a to TR2e. Visibility flags of the triangular patches TR1a, TR1b, and TR1e are “1”, and visibility flags of the triangular patches TR1c and TR1d are “0”. Visibility flags of the triangular patches TR2a, TR2d, and TR2e are “1”, and visibility flags of the triangular patches TR2b and TR2c are “0”. The “1”s or “0”s in the triangular patches TR1a to TR1e and the triangular patches TR2a to TR2e represent the visibility flags. Due to the subdivision processing, boundaries of occlusion are also boundaries between the visibility flags “1” and “0”.

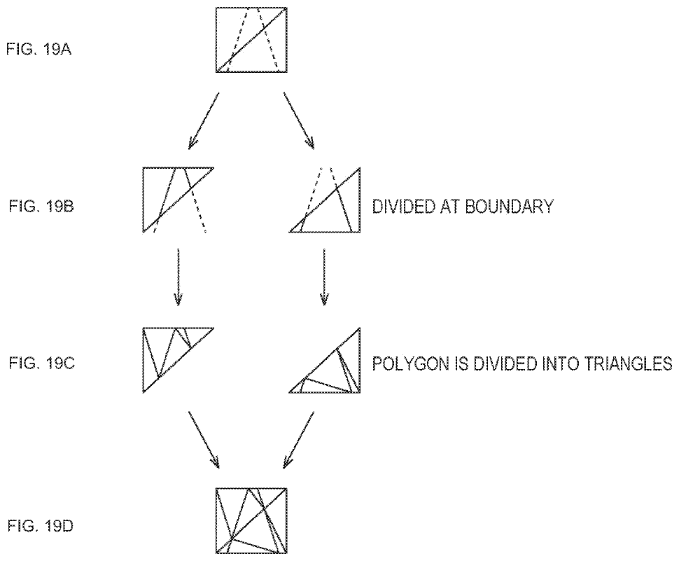

FIG. 19 is a diagram illustrating a procedure for the triangular patch subdivision processing.

A of FIG. 19 illustrates a state before the subdivision processing.

As illustrated in B of FIG. 19, the mesh subdivision unit 81 divides a triangular patch supplied from the mesh processing unit 44 at a boundary between visibility flags on the basis of a result of the visibility determination processing executed by the visibility determination unit 46.

Next, the mesh subdivision unit 81 determines whether a polygon that is not a triangle is included as a result of division of the triangular patch supplied from the mesh processing unit 44 as illustrated in C of FIG. 19. In a case where a polygon that is not a triangle is included, the mesh subdivision unit 81 connects vertices of the polygon to further divide the polygon into triangles.

When the polygon is divided, all patches become triangular patches as illustrated in D of FIG. 19, and boundaries between the triangular patches also become boundaries between visibility flags “1” and “0”.

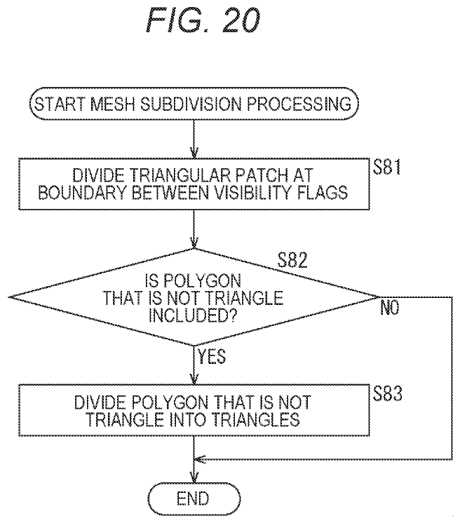

FIG. 20 is a flowchart of the triangular patch subdivision processing.

First, in step S81, the mesh subdivision unit 81 divides a triangular patch supplied from the mesh processing unit 44 at a boundary between visibility flags on the basis of a result of the visibility determination processing executed by the visibility determination unit 46.

In step S82, the mesh subdivision unit 81 determines whether a polygon that is not a triangle is included in a state after the triangular patch has been divided at the boundary between the visibility flags.

If it is determined in step S82 that a polygon that is not a triangle is included, the processing proceeds to step S83, and the mesh subdivision unit 81 connects vertices of the polygon that is not a triangle to further divide the polygon so that the polygon that is not a triangle is divided into triangles.

On the other hand, if it is determined in step S82 that a polygon that is not a triangle is not included, the processing of step S83 is skipped.

In a case where a polygon that is not a triangle is not included after the division at the boundary between the visibility flags (in a case where NO is determined in step S82), or after the processing of step S83, the mesh data after the subdivision is supplied to the visibility determination unit 46 and the packing unit 47, and the subdivision processing ends. The visibility determination unit 46 generates visibility information for the mesh data after the subdivision. The visibility determination unit 46 and the mesh subdivision unit 81 may be constituted by one block.

According to the modified example of the generation device 22, the boundaries between the visibility flags “1” and “0” coincide with the boundaries between the triangular patches, and this makes it possible to more accurately reflect visibility in the texture image of the imaging device 21, thereby improving the image quality of an object image generated on the reproduction side.

In the above description, in the image processing system 1, the generation device 22 generates a visibility flag for each triangular patch of mesh data that is a three-dimensional shape of an object, and supplies the mesh data containing the visibility information to the reproduction device 25. As a result, it is not necessary for the reproduction device 25 to determine whether or not a texture image (to be accurate, a corrected texture image) of each imaging device 21 transmitted from the distribution side can be used for pasting of color information (R, G, and B values) of the display object. In a case where the visibility determination processing is performed on the reproduction side, it is necessary to generate a depth image and determine whether or not the object is captured in the imaging range of the imaging device 21 from the depth information. This involves a large amount of calculation and has made the processing heavy. Supplying the mesh data containing the visibility information to the reproduction device 25 makes it unnecessary for the reproduction side to generate a depth image and determine visibility, and the processing load can be significantly reduced.

Furthermore, in a case where visibility is determined on the reproduction side, it is necessary to obtain 3D data of all objects, and the number of objects at the time of imaging cannot be increased or decreased. In this processing, the visibility information is known, and the number of objects can be increased or decreased. For example, it is possible to reduce the number of objects and select and draw only necessary objects, or to add and draw an object that does not exist at the time of imaging. Conventionally, in a case of drawing with an object configuration different from that at the time of imaging, it has been necessary to perform writing to a drawing buffer many times. However, in this processing, writing to an intermediate drawing buffer is not necessary.

Note that, in the example described above, a texture image (corrected texture image) of each imaging device 21 is transmitted to the reproduction side without compression coding. Alternatively, the texture image may be compressed by video codec and then transmitted.

Furthermore, in the example described above, 3D shape data of a 3D model of a subject is transmitted as mesh data represented by a polygon mesh, but the 3D shape data may be in other data formats. For example, the 3D shape data may be in a data format such as a point cloud or a depth map, and the 3D shape data may be transmitted with visibility information added. In this case, the visibility information can be added for each point or pixel.

Furthermore, in the example described above, visibility information is represented by two values (“0” or “1”) indicating whether or not the whole triangular patch is captured, but the visibility information may be represented by three or more values. For example, the visibility information may be represented by two bits (four values), for example, “3” in a case where three vertices of a triangular patch are captured, “2” in a case where two vertices are captured, “1” in a case where one vertex is captured, and “0” in a case where all are hidden.

### 11. Configuration Example of Computer

The series of pieces of processing described above can be executed not only by hardware but also by software. In a case where the series of pieces of processing is executed by software, a program constituting the software is installed on a computer. Here, the computer includes a microcomputer incorporated in dedicated hardware, or a general-purpose personal computer capable of executing various functions with various programs installed therein, for example.

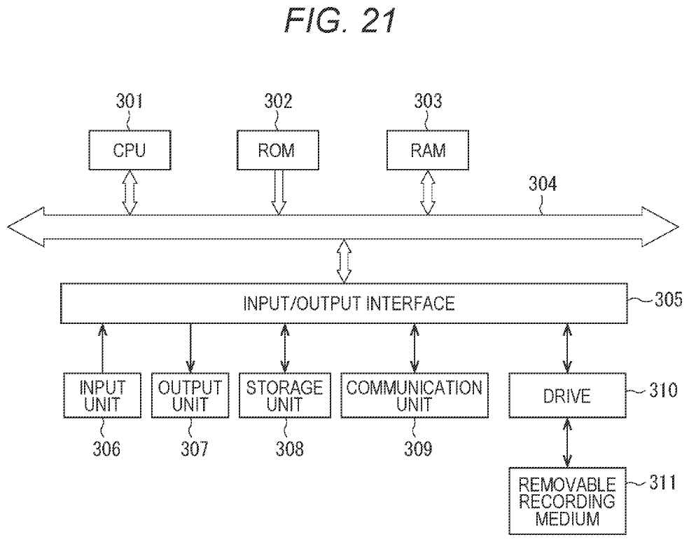

FIG. 21 is a block diagram illustrating a configuration example of hardware of a computer that executes the series of pieces of processing described above in accordance with a program.

In the computer, a central processing unit (CPU) 301, a read only memory (ROM) 302, and a random access memory (RAM) 303 are connected to each other by a bus 304.

The bus 304 is further connected with an input/output interface 305. The input/output interface 305 is connected with an input unit 306, an output unit 307, a storage unit 308, a communication unit 309, and a drive 310.

The input unit 306 includes a keyboard, a mouse, a microphone, a touch panel, an input terminal, or the like. The output unit 307 includes a display, a speaker, an output terminal, or the like. The storage unit 308 includes a hard disk, a RAM disk, a nonvolatile memory, or the like. The communication unit 309 includes a network interface or the like. The drive 310 drives a removable recording medium 311 such as a magnetic disk, an optical disk, a magneto-optical disk, or a semiconductor memory.

To perform the series of pieces of processing described above, the computer configured as described above causes the CPU 301 to, for example, load a program stored in the storage unit 308 into the RAM 303 via the input/output interface 305 and the bus 304 and then execute the program. The RAM 303 also stores, as appropriate, data or the like necessary for the CPU 301 to execute various types of processing.

The program to be executed by the computer (CPU 301) can be provided by, for example, being recorded on the removable recording medium 311 as a package medium or the like. Furthermore, the program can be provided via a wired or wireless transmission medium such as a local area network, the Internet, or digital satellite broadcasting.

Inserting the removable recording medium 311 into the drive 310 allows the computer to install the program into the storage unit 308 via the input/output interface 305. Furthermore, the program can be received by the communication unit 309 via a wired or wireless transmission medium and installed into the storage unit 308. In addition, the program can be installed in advance in the ROM 302 or the storage unit 308.

Note that, in the present specification, the steps described in the flowcharts may be of course performed in chronological order in the order described, or may not necessarily be processed in chronological order. The steps may be executed in parallel, or at a necessary timing such as when called.

In the present specification, a system means a set of a plurality of components (devices, modules (parts), and the like), and it does not matter whether or not all components are in the same housing. Thus, a plurality of devices housed in separate housings and connected via a network, and one device having a plurality of modules housed in one housing are both systems.

Embodiments of the present technology are not limited to the embodiments described above but can be modified in various ways within a scope of the present technology.

For example, it is possible to adopt a mode in which all or some of the plurality of embodiments described above are combined.

For example, the present technology can have a cloud computing configuration in which a plurality of devices shares one function and collaborates in processing via a network.

Furthermore, each step described in the flowcharts described above can be executed by one device or can be shared by a plurality of devices.

Moreover, in a case where a plurality of pieces of processing is included in one step, the plurality of pieces of processing included in that step can be executed by one device or can be shared by a plurality of devices.

Note that the effects described in the present specification are merely examples and are not restrictive, and effects other than those described in the present specification may be obtained.

Note that the present technology can be configured as described below.

(1)

An image processing apparatus including:

a determination unit that determines whether or not a subject is captured in texture images corresponding to captured images captured one by each one of a plurality of imaging devices; and

an output unit that adds a result of the determination by the determination unit to 3D shape data of a 3D model of the subject and then outputs the result of the determination.

(2)

The image processing apparatus according to (1), in which

the 3D shape data of the 3D model of the subject is mesh data in which a 3D shape of the subject is represented by a polygon mesh.

(3)

The image processing apparatus according to (2), in which

the determination unit determines, as the result of the determination, whether or not the subject is captured for each triangular patch of the polygon mesh.

(4)

The image processing apparatus according to (2) or (3), in which

the output unit adds the result of the determination to the 3D shape data by storing the result of the determination in normal vector information of the polygon mesh.

(5)

The image processing apparatus according to any one of (1) to (4), in which

the texture images are images in which lens distortion and color of the captured images captured by the imaging devices are corrected.

(6)

The image processing apparatus according to any one of (1) to (5), further including:

a depth map generation unit that generates a depth map by using a plurality of the texture images and camera parameters corresponding to the plurality of imaging devices,

in which the determination unit generates the result of the determination by using a depth value of the depth map.

(7)

The image processing apparatus according to any one of (1) to (6), further including:

a subdivision unit that divides a triangular patch in such a way that a boundary between results of the determination indicating whether or not the subject is captured coincides with a boundary between triangular patches of the 3D model of the subject.

(8)

The image processing apparatus according to any one of (1) to (7), further including:

an image transmission unit that transmits the texture images corresponding to the captured images of the imaging devices and camera parameters.

(9)

An image processing method including:

determining, by an image processing apparatus, whether or not a subject is captured in texture images corresponding to captured images captured one by each one of a plurality of imaging devices, and adding a result of the determination to 3D shape data of a 3D model of the subject and then outputting the result of the determination.

(10)

An image processing apparatus including:

a drawing processing unit that generates an image of a 3D model of a subject on the basis of 3D shape data containing a determination result that is the 3D shape data of the 3D model to which the determination result indicating whether the subject is captured in a texture image is added.

(11)

The image processing apparatus according to (10), further including:

a camera selection unit that selects, from among N imaging devices, M (M≤N) imaging devices and acquires M texture images corresponding to the M imaging devices,

in which the drawing processing unit refers to the determination result and selects, from among the M texture images, K (K≤M) texture images in which the subject is captured.

(12)

The image processing apparatus according to (11), in which the drawing processing unit generates an image of the 3D model by blending pieces of color information of L (L K) texture images among the K texture images.

(13)

The image processing apparatus according to any one of (10) to (12), further including:

a separation unit that separates the 3D shape data containing the determination result into the determination result and the 3D shape data.

(14)

An image processing method including:

generating, by an image processing apparatus, an image of a 3D model of a subject on the basis of 3D shape data containing a determination result that is the 3D shape data of the 3D model to which the determination result indicating whether the subject is captured in a texture image is added.

### REFERENCE SIGNS LIST

1 Image processing system
21 Imaging device
22 Generation device
23 Distribution server
25 Reproduction device
26 Display device
27 Viewing position detection device
41 Distortion/color correction unit
44 Mesh processing unit
45 Depth map generation unit
46 Visibility determination unit
47 Packing unit
48 Image transmission unit
61 Unpacking unit
62 Camera selection unit
63 Drawing processing unit
81 Mesh subdivision unit
301 CPU
302 ROM
303 RAM
306 Input unit
307 Output unit
308 Storage unit
309 Communication unit
310 Drive

1. An image processing apparatus comprising:
a determination unit that determines whether or not a subject is captured in texture images corresponding to captured images captured one by each one of a plurality of imaging devices; and
an output unit that adds a result of the determination by the determination unit to 3D shape data of a 3D model of the subject and then outputs the result of the determination.

2. The image processing apparatus according to claim 1, wherein
the 3D shape data of the 3D model of the subject is mesh data in which a 3D shape of the subject is represented by a polygon mesh.

3. The image processing apparatus according to claim 2, wherein
the determination unit determines, as the result of the determination, whether or not the subject is captured for each triangular patch of the polygon mesh.

4. The image processing apparatus according to claim 2, wherein
the output unit adds the result of the determination to the 3D shape data by storing the result of the determination in normal vector information of the polygon mesh.

5. The image processing apparatus according to claim 1, wherein
the texture images are images in which lens distortion and color of the captured images captured by the imaging devices are corrected.

6. The image processing apparatus according to claim 1, further comprising:
a depth map generation unit that generates a depth map by using a plurality of the texture images and camera parameters corresponding to the plurality of imaging devices,
wherein the determination unit generates the result of the determination by using a depth value of the depth map.

7. The image processing apparatus according to claim 1, further comprising:
a subdivision unit that divides a triangular patch in such a way that a boundary between results of the determination indicating whether or not the subject is captured coincides with a boundary between triangular patches of the 3D model of the subject.

8. The image processing apparatus according to claim 1, further comprising:
an image transmission unit that transmits the texture images corresponding to the captured images of the imaging devices and camera parameters.

9. An image processing method comprising:
determining, by an image processing apparatus, whether or not a subject is captured in texture images corresponding to captured images captured one by each one of a plurality of imaging devices, and adding a result of the determination to 3D shape data of a 3D model of the subject and then outputting the result of the determination.

10. An image processing apparatus comprising:
a drawing processing unit that generates an image of a 3D model of a subject on a basis of 3D shape data containing a determination result that is the 3D shape data of the 3D model to which the determination result indicating whether the subject is captured in a texture image is added.

11. The image processing apparatus according to claim 10, further comprising:
a camera selection unit that selects, from among N imaging devices, M (M≤N) imaging devices and acquires M texture images corresponding to the M imaging devices,
wherein the drawing processing unit refers to the determination result and selects, from among the M texture images, K (K≤M) texture images in which the subject is captured.

12. The image processing apparatus according to claim 11, wherein
the drawing processing unit generates an image of the 3D model by blending pieces of color information of L (L≤K) texture images among the K texture images.

13. The image processing apparatus according to claim 10, further comprising:
a separation unit that separates the 3D shape data containing the determination result into the determination result and the 3D shape data.

14. An image processing method comprising:
generating, by an image processing apparatus, an image of a 3D model of a subject on a basis of 3D shape data containing a determination result that is the 3D shape data of the 3D model to which the determination result indicating whether the subject is captured in a texture image is added.
